(19) United States
(12) Patent Application Publication
(10) Pub. No.: US 2019/0013747 A1
(43) Pub. Date: Jan. 10, 2019

(54) MAGNETICALLY LEVITATED ROTOR AND A ROTARY MACHINE WITH SUCH A ROTOR

(71) Applicant: Levitronix GmbH, Zurich (CH)

(72) Inventors: Natale BARLETTA, Zürich (CH); Giampiero FOIERA, Spreitenbach (CH); Thomas EBERLE, Winterthur (CH); Reto SCHÖB, Bäch SZ (CH); Thomas GEMPP, Rudolfstetten (CH); Mathias HOFFMANN, Niederlenz (CH)

(21) Appl. No.: 16/013,138

(22) Filed: Jun. 20, 2018

(30) Foreign Application Priority Data
Jul. 4, 2017 (EP) 17179501.6

(51) Int. Cl. H02N 15/00; H02K 1/04; H02K 1/27; H02K 1/28; F04D 13/06; F04D 7/06

(52) U.S. Cl. CPC H02N 15/00; H02K 1/04; F04D 7/06; H02K 1/28; F04D 13/0653; H02K 1/2733

(57) ABSTRACT

A magnetically levitated rotor includes a magnetically effective core and a sheathing made of a thermoplastically processible fluoropolymer. The sheathing completely encloses the magnetically effective core. The magnetically effective core comprises at least one permanent magnet and each permanent magnet has a metallic coating for protection against acidic or chemically aggressive substances. A plastic coating is disposed between the metallic coating and the sheathing, and includes a polymer belonging to the family of parylenes.

### CROSS-REFERENCE TO RELATED APPLICATION

This application claims priority to European Application No. 17179501.6, filed Jul. 4, 2017, the contents of which are hereby incorporated herein by reference.

### BACKGROUND

### Field of the Invention

The invention relates to a rotor for a rotary machine with a magnetically levitated rotor.

### Background of the Invention

Rotary machines with magnetically levitated rotors, for example centrifugal pumps or mixing devices or stirring devices are used in many technical fields, in particular for applications in which highly pure fluids are conveyed, stirred or mixed, without the fluids being contaminated by abrasion particles from mechanical bearings. In the semiconductor industry, for example, magnetically levitated rotors are used for conveying ultrapure water as well as acidic, oxidizing or otherwise chemically aggressive fluids, as they are used in the semiconductor industry for the production or processing of semiconductor structures. It is crucial that no metal ions get into the liquids from the magnetically levitated rotor, because such metal ions could change the doping of the semiconductors.

With respect to the design of rotary machines, in particular centrifugal pumps, with magnetically levitated rotors, devices are known, in which the rotor is levitated in a contactless manner by separate magnetic bearings, while the rotation of the rotor is driven by a separate drive unit. In this case, each magnetic bearing typically comprises a bearing stator interacting with a magnetically effective core of the rotor to magnetically levitate the rotor. The drive unit comprises a drive stator with which the rotor is set in rotation according to the principle of an electromagnetic rotary drive.

However, such designs of rotary machines with magnetically contactless levitated rotors are also known where no separate magnetic bearings are provided, but the bearing function and the drive function are realized with the same stator. The term “bearing-less motor” has become established for such designs because no separate magnetic bearings are provided for the rotor. The bearing function and the drive function cannot be separated from each other. These particularly efficient bearing-less motors are characterized in particular by their extremely compact design and simultaneous realization of the “contactless” concept. Thus, a bearing-less motor is an electromagnetic rotary drive, in which the rotor is levitated completely magnetically with respect to the stator, wherein no separate magnetic bearings are provided. For this purpose, the stator is designed as a bearing stator and drive stator, which is both the stator of the electric drive and the stator of the magnetic bearing. A rotating magnetic field can be generated with the electrical windings of the bearing stator and drive stator, which rotating magnetic field on the one hand exerts a torque on the rotor causing it to rotate, and which on the other hand exerts a freely adjustable transverse force on the rotor so that its radial position can be actively controlled or regulated.

The rotor of the rotary machine is often an integral rotor, in particular when designed as a pump, mixer or stirrer, which integral rotor is both the rotor of the electromagnetic drive and the rotor of the pump or mixer, which affects the fluid.

Different concepts are also known for the design of the magnetically effective core of the rotor. For example, the magnetically effective core can only consist of one or more permanent magnets, so that the entire magnetically effective core of the rotor is made of permanent magnetic material. However, such designs are also known, in which the magnetically effective core comprises one or more permanent magnets being combined with soft magnetic parts. Usually the soft magnetic parts are made of iron or nickel-iron or silicon-iron.

Regardless of whether the rotary machine, for example the centrifugal pump, is designed with separate magnetic bearings or according to the concept of the bearing-less motor, it is particularly important for the conveying of acidic or chemically aggressive substances, to protect the magnetically effective core of the rotor and in particular also the permanent magnet(s) against such aggressive substances. The materials typically used for permanent magnets, such as neodyne, samarium or cobalt for example, generally have a very low resistance to such aggressive substances.

Acidic or other chemically aggressive substances, which must be used and conveyed in semiconductor production, are e.g. ozone water (O₃, dissolved in H₂O), sulphuric acid (H₂SO₄), phosphoric acid (H₃PO₄), hydrochloric acid (HCl), hydrofluoric acid (HF), nitric acid (HNO₃), ozone (O₃) or mixtures, for example of sulphuric acid (H₂SO₄) and hydrogen peroxide (H₂O₂) or of sulphuric acid (H₂SO₄) and nitric acid (HNO₃). To make matters worse, these aggressive substances often have to be provided at increased temperatures, e.g. at 150° C. to 200° C. or even more.

To protect against such aggressive substances, it is known to provide the magnetically effective core of the rotor and in particular the permanent magnets or the permanent magnet with a plastic sheathing of a fluorinated hydrocarbon, because these hydrocarbons show a quite good resistance to chemically aggressive substances, in particular to the acids mentioned above.

However, the fluorinated hydrocarbons very often do not form a sufficient barrier to gaseous components of the chemicals. Thus, an encapsulation from a fluorinated hydrocarbon has only a very limited barrier effect against ozone (O₃), which may be contained, for example, in a mixture to be conveyed of sulphuric acid and ozone (H₂SO₄ with O₃) in substantial quantities. Furthermore, investigations have shown that corrosion occurs even with such sheathings of fluorinated hydrocarbons after relatively short operating times, in particular on the permanent magnets of the rotor. This can result in inflation of the rotor, in degradation of the metallic coating, in chipping off parts of the rotor core or of the sheathing up to a complete destruction of the magnetically effective core of the rotor.

In EP-A-2 549 113 it has therefore been proposed to provide the permanent magnet of the rotor with a double sheathing, namely with an inner metallic sheathing completely enclosing the permanent magnet, and with an outer sheathing of a fluorinated hydrocarbon completely enclosing the metallic sheathing.

The idea is that the outer plastic sheathing protects the permanent magnet or the magnetically effective core against the normally liquid acids, while the inner metallic sheathing protects the magnetically effective core against gaseous components, which can penetrate the plastic sheathing relatively well.

### SUMMARY

Even though this concept of double sheathing has proven itself in practice, there is still need for improvement. On the one hand, the thick-walled metallic sheathing of the permanent magnet of the rotor proposed in EP-A-2 549 113 is relatively difficult to implement, because the welding of the individual parts of the sheathing must be gas-tight, but on the other hand, the energy input during welding must be kept sufficiently low so that the structure of the permanent magnetic material does not change. This problem is complicated by the fact that the sheathing of metal must be relatively close to the permanent magnet, because the magnetic air gap cannot be increased during a magnetic levitating without a high loss of force. In doing so, the heat required for welding the sheathing is dissipated directly into the permanent magnets of the rotor. In addition, ozone, hydrogen or acid vapors can diffuse through the plastic and attack the metallic sheathing. Once the metallic sheathing of the rotor has been attacked, metal ions can diffuse through the plastic sheathing into the fluid to be conveyed and contaminate the fluid. In applications in the semiconductor industry, such metal ions in the fluid can have extremely negative consequences, because, for example, even very low concentrations of the dissolved metal ions can change the doping of the semiconductor structures to be treated in an uncontrolled manner and, in the worst case, make the semiconductor products unusable.

Therefore, great efforts have been made to better protect the magnetically effective core of the rotor against acidic or other chemically aggressive substances and at the same time to avoid the problem described above of welding a metallic sheathing of the permanent magnet. For this purpose, a wide variety of metal layers were galvanically applied to the permanent magnet and their corrosion resistance were tested. But even galvanically applied metallic sheathings, for example using gold or rhodium, which are considered extremely inert, have surprisingly not led to really satisfactory results. After a relatively short service life of 100-200 hours, for example, massive corrosion can occur on the rotor.

It may be suggested that in particular substances with very small molecules, for example hydrochloric acid (HCl) or hydrofluoric acid (HF) or ozone (O₃), diffuse through the sheathing via lattice defects or microstructure defects in the metallic layer, e.g. blowholes or capillary cracks, and then attack the permanent magnet or the magnetically effective core of the rotor so that the rotor corrodes from the inside.

The present invention is dedicated to this problem.

Starting from this state of the art, it is therefore an object of the invention to propose a rotor which can be magnetically levitated for a rotary machine in which rotor the magnetically effective core and in particular a permanent magnet of the rotor is particularly well protected against oxidizing and acidic substances or other chemically aggressive substances. Furthermore, the invention is intended to propose a rotary machine with such a rotor.

The objects of the invention meeting this problem are characterized by the features described herein.

According to the invention, a rotor that can be magnetically levitated is proposed for a rotary machine with a magnetically levitated rotor, which rotor has a magnetically effective core and a sheathing made of a thermoplastically processible fluoropolymer, the sheathing completely enclosing the magnetically effective core, wherein the magnetically effective core comprises at least one permanent magnet and wherein each permanent magnet has a metallic coating for protection against acidic or chemically aggressive substances, and wherein a plastic coating is disposed between the metallic coating and the sheathing, which plastic coating includes a polymer belonging to the family of parylenes.

Preferably, the metallic coating adheres directly to the permanent magnet.

Very complex and extensive investigations have shown that precisely this combination of a metallic coating of the permanent magnet, which adheres directly to the permanent magnet, with an outer sheathing of a fluoropolymer and a parylene coating disposed there between ensure a particularly good and long-lasting protection of the magnetically effective core of the rotor against acids, acidic fluids and other chemically aggressive substances such as ozone or hydrogen, for example. The magnetically effective core of the rotor is protected both against aggressive liquid components, e.g. liquid acids, and against gaseous components by this special combination. In particular, the diffusion of substances with very small molecules, for example hydrogen (H₂), ozone (O₃), hydrofluoric acid (HF) or hydrochloric acid (HCl), to the magnetically effective core of the rotor or to the permanent magnet is also prevented or at least significantly reduced. In comparison to the fluoropolymers of the outer sheathing, the polymer chains of the parylenes are significantly longer, whereby they form a much better diffusion barrier compared to the fluoropolymers.

Parylene is also used as a trade name for a group of poly(p-xylylene) polymers produced by chemical vapor deposition. The starting material is p-xylene (xylene is also called xylene or dimethylbenzene) or halogenated derivatives thereof. Depending on which substituents are attached to the benzene ring, different parylenes are distinguished. In the basic product poly-p-xylylene, known as parylene N, the benzene ring has only aromatic hydrogen atoms, i.e. each of the four radicals on the benzene ring is a hydrogen atom. In addition, other commercially available products are in particular parylene C, parylene D and parylene HT. In parylene C, one of the aromatic hydrogen atoms is replaced by a chlorine atom, in parylene D two of the aromatic hydrogen atoms are each replaced by one chlorine atom and parylene HT is a halogenated derivative, in which the alpha hydrogen atoms of the dimer are each replaced by a fluorine atom.

The permanent magnet or permanent magnets of the magnetically effective core of the rotor are preferably made of neodyne-iron-boron (NdFeB) or samarium-cobalt (SmCo) alloys.

It has proved to be advantageous if the metallic coating adhering directly to the rotor comprises at least one layer made of nickel, of gold or of rhodium.

Particularly good protection can be achieved if the metallic coating comprises a plurality of coatings, in particular at least three, which are arranged one above the other, the innermost layer being disposed directly on a surface of the permanent magnet and preferably consisting of or including nickel. Nickel is particularly preferred because nickel adheres well to NdFeB-based alloys as well as to SmCo-based alloys. Nickel is also preferred as the outermost metallic layer, since parylenes also adhere well to nickel, in particular better than to precious metals such as gold or rhodium.

In a preferred embodiment, the metallic coating comprises exactly three layers, which are arranged one above the other, wherein the innermost layer and the outermost layer each consist of nickel and wherein the intermediate middle layer preferably consists of (or includes) copper or of gold or of rhodium.

In the multi-layer metallic coating, the innermost layer is first applied to a surface of the permanent magnet. Subsequently, the middle layer is applied, which can be used, for example, to fill blowholes, capillary cracks or other microstructure defects in the innermost coating. Then, the middle layer forms a particularly flat and smooth base for the outermost layer. Preferably, the metallic coating is deposited on the surface of the permanent magnet by galvanic technology (electroplating) or by currentless metal deposition (chemical deposition without external current).

In the event that the metallic coating comprises three layers, the following layer combinations are particularly preferred, whereby the sequence is indicated from the inside—i.e. from the surface of the permanent magnet—to the outside: nickel (Ni), copper (Cu), nickel (Ni) or nickel, gold, nickel or nickel, rhodium (Rh), nickel. In the event that the metallic layer coating has only one layer, it is preferably of nickel, of gold or of rhodium.

The total thickness of the metallic coating is preferably 30 to 100 micrometers and particularly preferred 50 to 60 micrometers.

With respect to the sheathing, it is preferred if the sheathing consists of (or includes) a perfluoroalkoxy polymer (PFA) or of ethylene chlorotrifluoroethylene (ECTFE) or of polyvinylidene fluoride (PVDF). In addition to their resistance to acids, these thermoplastically processible fluoropolymers have the particular advantage, that they can be injection molded and welded, for example by infrared welding. This is advantageous for the production of the rotor.

The sheathing of the fluoropolymer preferably comprises at least two parts, which are welded together, wherein infrared welding is preferred for this purpose. To protect the plastic coating made of parylene from excessive heat input, especially during the welding process, it is an advantageous measure if a heat protection film, preferably a polyimide film, is disposed between the plastic coating and the sheathing. For this purpose, the material available under the trade name KAPTON is suitable, for example.

According to a preferred embodiment, the plastic coating consists of (or includes) a fluorinated parylene, preferably of aliphatically fluorinated parylene. In particular, two variants of fluorinated parylene are commercially available today, namely the aliphatically fluorinated variant designated as Parylene AF4 and the aromatically fluorinated variant designated as Parylene VT4. Aliphatically fluorinated parylene is a variant in which the two hydrogen atoms in the aliphatic carbon bonds between the benzene rings are replaced by two fluorine atoms. For this purpose, the alpha hydrogen atoms of the dimer are replaced by fluorine atoms to produce the parylene. In the aromatically fluorinated variant, the aromatic hydrogen atoms are each replaced by a fluorine atom, i.e. each of the four radicals on the benzene ring is a fluorine atom.

Fluorinated parylene, and in particular aliphatically fluorinated parylene, has the advantage that it has a high thermal stability, i.e. it is very resistant to high temperatures, and it can be exposed to temperatures of up to 450° for at least a short time without degradation symptoms. Of course, the polyimide heat protection film can also be disposed between the plastic coating of parylene and the sheathing when using fluorinated parylene.

Preferably, the metallic coating completely encloses the magnetically effective core, i.e. the entire magnetically effective core is completely enclosed in the metallic coating. According to a first embodiment, the magnetically effective core of the rotor has only one permanent magnet, for example of a permanent magnetic ring. In this case, each surface of the permanent magnet is completely disposed with the metallic coating so that the entire permanent magnet is completely coated with the metallic coating, i.e. completely enclosed or encapsulated by the metallic coating.

It is also preferred, if the plastic sheathing completely encloses the magnetically effective core. Usually, plastic coatings made of parylene are produced by vapour deposition as a polymer layer on the substrate to be coated. Therefore, for example, the magnetically effective core of the rotor or the permanent magnet can first be provided with the metallic coating and the plastic coating of parylene is then deposited on this metallic coating.

A preferred embodiment is that the metallic coating is provided directly on each permanent magnet and each permanent magnet is completely enclosed by the metallic coating directly provided on it.

Furthermore, it is preferred that the plastic coating is provided directly on the metallic coating and that each metallic coating is completely enclosed by the plastic coating directly provided on it.

As already mentioned, the magnetically effective core has a permanent magnet in a first embodiment, wherein the permanent magnet is preferably designed in one piece and in particular preferably in the form of a ring.

According to a preferred embodiment, the sheathing has a cup-shaped housing part receiving the magnetically effective core and a cover being welded to the housing part, wherein the cup-shaped housing part is preferably designed in such a manner that an air gap exists between the magnetically effective core and the housing part. If the magnetically effective core includes the metallic coating and with the plastic coating, this air gap has a width in the radial direction of, for example, about 0.1 mm between the wall of the housing part and the coated magnetically effective core. An air gap is also provided in the axial direction, i.e. at the bottom of the cup-shaped housing part or at the cover, which has a width of about 0.5-1 mm in the axial direction.

Furthermore, a rotary machine for affecting a fluid, in particular a centrifugal pump or a mixing device is proposed by the invention, with a rotor that can be magnetically levitated and with a stator, with which the rotor can be driven in a magnetically contactless manner for rotation about an axial direction in the operating state, wherein the rotor is magnetically levitated and designed according to the invention.

The rotary machine is preferably designed as a bearing-less motor, in which the stator is designed as a bearing stator and drive stator, with which the rotor can be driven in a magnetically contactless manner in the operating state and can be levitated in a magnetically contactless manner at least radially with respect to the stator.

Further advantageous measures and embodiments of the invention result from the dependent claims.

### BRIEF DESCRIPTION OF THE DRAWINGS

The invention will be explained in more detail hereinafter with reference to the drawings.

FIG. 1 is a sectional view of a first embodiment of a rotary machine according to the invention with a first embodiment of a rotor according to the invention,

FIG. 2 is a sectional view of the rotor that can be magnetically levitated of FIG. 1,

FIG. 3 is an enlarged view of detail I of FIG. 2,

FIG. 4 is a sectional view of a second embodiment of a rotary machine according to the invention with a second embodiment of a rotor according to the invention,

FIG. 5 is a sectional view of the rotor that can be magnetically levitated of FIG. 2,

FIG. 6 is a section through the rotor of FIG. 5 along the section line VI-VI in FIG. 5,

FIG. 7 is a schematic sectional view of a first variant for the rotor of FIG. 5,

FIG. 8 is a schematic sectional view of a second variant for the rotor of FIG. 5, and

FIG. 9 is a schematic sectional view of a third variant for the rotor of FIG. 5.

### DETAILED DESCRIPTION OF THE EMBODIMENTS

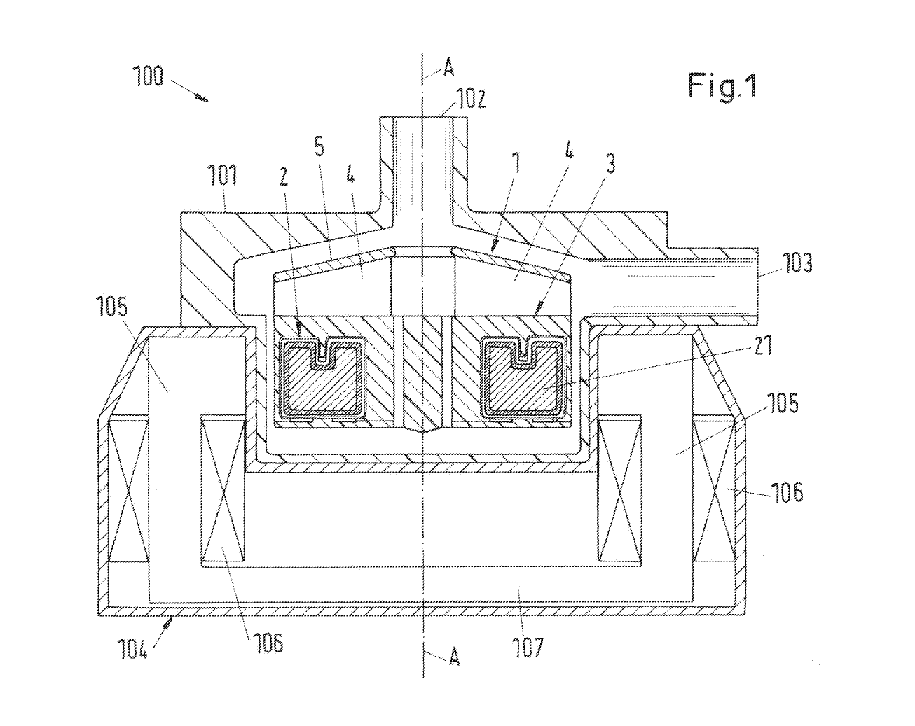

FIG. 1 shows a first embodiment of a rotary machine according to the invention with a first embodiment of a rotor according to the invention in a first sectional view. Here, the rotary machine is designed as a centrifugal pump, which is referred to as a whole with the reference sign 100. Such centrifugal pumps 100 can be used especially in the semiconductor industry for conveying acidic fluids or chemically aggressive fluids. Such fluids may contain sulphuric acid (H₂SO₄), phosphoric acid (H₃PO₄), hydrochloric acid (HCl), hydrofluoric acid (HF), nitric acid (HNO₃), ozone (O₃) or mixtures for example of sulphuric acid (H₂SO₄) and hydrogen peroxide (H₂O₂) or of sulphuric acid (H₂SO₄) and nitric acid (HNO₃).

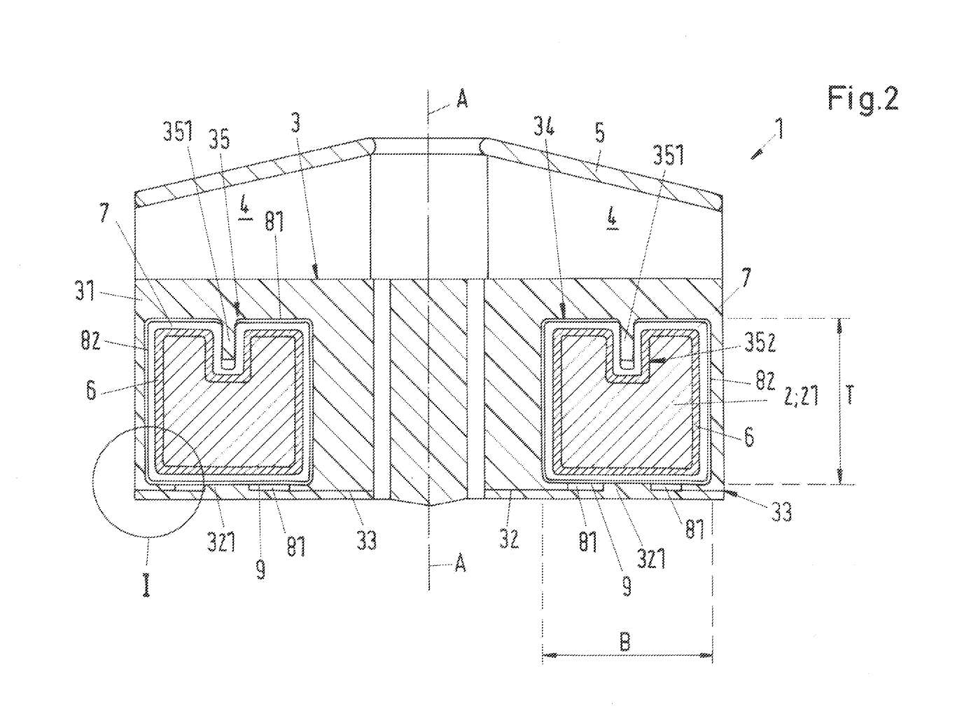

The centrifugal pump 100 comprises a pump housing 101 with an inlet 102 and an outlet 103 for the fluid to be conveyed. A first embodiment of a rotor that can be magnetically levitated according to the invention is disposed in the pump housing 101, which rotor is referred to as a whole with the reference sign 1. For a better understanding, FIG. 2 shows a sectional view of the rotor 1 that can be magnetically levitated of FIG. 1. Rotor 1 has a magnetically effective core 2, which comprises at least one permanent magnet 21, to drive the rotation of the rotor 1 about a set rotation axis, which defines an axial direction A. A direction perpendicular to the axial direction A is described as the radial direction.

In the first embodiment, the magnetically effective core 2 includes only the permanent magnet 21, which here is designed as a ring-shaped permanent magnet 21. Preferably the ring-shaped permanent magnet 21 is in one piece. However, it is also possible that the permanent magnet 21 comprises several segments, which complement each other to form a ring. In the operating state, the ring-shaped permanent magnet 21 is arranged in such a way that it extends around the set rotation axis.

The rotor 1 further comprises a sheathing 3 made of a thermoplastically processible fluoropolymer, which completely encloses the magnetically effective core 2 so that the magnetically effective core 2 is completely embedded in the sheathing 3 and encapsulated by the sheathing 3. The sheathing 3 consists of (or includes) a perfluoroalkoxy polymer (PFA). Alternatively, the sheathing 3 can also include ethylene chlorotrifluoroethylene (ECTFE) or of polyvinylidene fluoride (PVDF). A plurality of vanes 4 is provided on the sheathing 3, with which the fluid can be conveyed from the inlet 102 to the outlet 103. Furthermore, a cover plate 5 covering the vanes 4 is provided, which covers the vanes 4 on their side facing away from the sheathing 3. The pump housing 101 is preferably made of a plastic. This can be the same plastic of which the sheathing 3 is made or another plastic. The pump housing 101 preferably consists, at least essentially, of a fluoropolymer. Plastics or polymers, especially fluoropolymers, which are not thermoplastically processible, i.e. which cannot be welded or injection moulded, are also suitable for the pump housing 101.

The pump housing 101 is designed in such a manner that it can be inserted into a stator 104, with which the rotor 1 can be driven in a magnetically contactless manner for rotation about an axial direction A and can be levitated in a magnetically contactless manner at least in the radial direction. Thus, the rotor 1 is designed as an integral rotor 1, which forms both the pump rotor 1 and the rotor 1 of the electromagnetic rotary drive.

The stator 104 has several coil cores 105 in a manner known per se, which have coils or windings 106, with which the rotor 1 can be driven in a magnetically contactless manner in the operating state. The coil cores 105 are connected by a conclusion 107, which preferably consists of (or includes) iron. In the first embodiment, the stator 104 is designed as bearing stator and drive stator 104, with which the rotor 1 can be driven in a magnetically contactless manner in the operating state and can be levitated in a magnetically contactless manner without contact with respect to the stator 104. Thus, the stator 104 and the rotor 1 form an electromagnetic rotary drive, which is preferably designed according to the principle of a bearing-less motor.

In a bearing-less motor, the rotor 1 can be driven in a magnetically contactless manner and can be levitated in a magnetically contactless manner with respect to the stator 104. For this purpose, the stator 104 is designed as bearing stator and drive stator 104, with which the rotor 1 can be driven in a magnetically contactless manner around the set rotation axis—i.e. it can be rotated and levitated in a magnetically contactless manner with respect to the stator 104.

The bearing-less motor is well-known to the person skilled in the art, so that a detailed description of its function is no longer necessary. The term bearing-less motor refers to the fact that the rotor 1 is completely magnetically levitated, wherein no separate magnet bearings are provided. For this purpose, the stator 104 is designed as bearing stator and drive stator 104, it is both the stator of the electric drive and the stator of the magnetic bearing. The stator 104 comprises the windings 106, with which a magnetic rotary field can be generated, which on the one hand exerts a torque on the rotor 1, which causes its rotation, and which on the other hand exerts a freely adjustable transverse force on the rotor 1 so that its radial position—i.e. its position in the radial plane perpendicular to the axial direction A—can be actively controlled or regulated. Thus, at least three degrees of freedom of the rotor 1 can be actively controlled. The rotor 1 is at least passively magnetic with regard to its axial deflection in the axial direction A, i.e. it is not controllable, stabilized by reluctance forces. The rotor 1 can also be passively magnetically stabilized with respect to the remaining two degrees of freedom, namely tilting with respect to the radial plane perpendicular to the set rotation axis—depending on the design.

In contrast to conventional magnetic bearings, the magnetic bearing and the drive of the motor of a bearing-less motor are realized via electromagnetic rotary fields, whose sum generates on the one hand a drive torque on the rotor 1, as well as a freely adjustable transverse force with which the radial position of the rotor 1 can be controlled. These rotary fields may either be generated separately—i.e. with different coils—, or the rotary fields can be generated by mathematically superimposing the required currents or voltages and then using a single coil system. A characteristic feature of the bearing-less motor is that the drive function cannot be separated from the bearing function. This is a significant difference to designs with separate magnetic bearings, in which the drive function is separated from the bearing function.

To place the pump housing 101 with the rotor 1 in the stator 104, the stator 104 has a substantially cylindrical recess into which the pump housing 101 can be inserted, so that the coil cores 105 with the windings 106 surround the rotor 1. The rotor 1 is centrally arranged between the stator poles formed by the coil cores 105. Thus, the rotor 1 and the stator 104 represent an electromagnetic rotary drive, which is designed according to the principle of the internal rotor.

In the embodiment described here, the centrifugal pump 100, more precisely the rotary drive formed by the stator 104 and the rotor 1, is designed as a so-called temple motor. The characteristic feature of a temple motor design is that the stator 104 comprises a plurality of separate coil cores 105, each of which is L-shaped with a longitudinal leg and a transverse leg. Each longitudinal leg extends from a first end in the axial direction A to a second end, from which the transverse leg extends inwards in the radial direction and forms a stator pole. All first ends of the longitudinal legs—these are the lower ends according to the illustration in FIG. 1—are connected to each other by the conclusion 107. The conclusion 107 comprises several segments, each of which connects the first end of a coil core 105 to the first end of the adjacent coil core 105. The individual coil cores 105 are preferably arranged in such a manner, that they surround the rotor 1 in a circle and are arranged equidistantly on this circle. During operation, the rotor 1 is levitated in a magnetically contactless manner between the stator poles pointing radially inwards. The magnetically effective core 2 of the rotor is at the same height as the stator poles with respect to the axial direction A. The parallel longitudinal legs of the coil cores 105, which all extend parallel to the axial direction A and which surround the rotor 1, are the ones that gave the temple motor its name, because these parallel longitudinal legs resemble the columns of a temple.

Another feature of the temple motor is that the windings 106 of the stator 104 are each arranged around the longitudinal legs of the coil cores 105 and are thus arranged outside the magnetic rotor plane, below the magnetic rotor plane according to the illustration. The magnetic rotor plane is the magnetic center plane of the magnetically effective core 2 of the rotor 1. This is the plane perpendicular to the axial direction A in which the rotor 1 or the magnetically effective core 2 of the rotor 1 is levitated in the operating state if the rotor 1 is not tilted. In general, the magnetic rotor plane is the geometric center plane of the magnetically effective core 2 of the rotor 1, which is perpendicular to the axial direction A.

Preferably, the windings 106 are arranged completely below the magnetically effective core 2. Thus, the windings 106 are not arranged in the plane in which the rotor 1 is driven and levitated in the operating state. In contrast to other electromagnetic rotary drives, in which the windings of the stator are arranged in such a manner that the coil axes each lie in the magnetic rotor plane, i.e. in the plane in which the rotor is levitated, the windings 106 of the stator 104 are arranged in the temple motor in such a manner that the axes of the windings 106 are perpendicular to the magnetic rotor plane and are thus aligned parallel to the axial direction A.

It is clear that the invention is not limited to such embodiments as a temple motor. Numerous other embodiments of the stator 104 are also possible. The only important thing is that the rotor 1 can be driven in a magnetically contactless manner for rotation about the axial direction in the operating state.

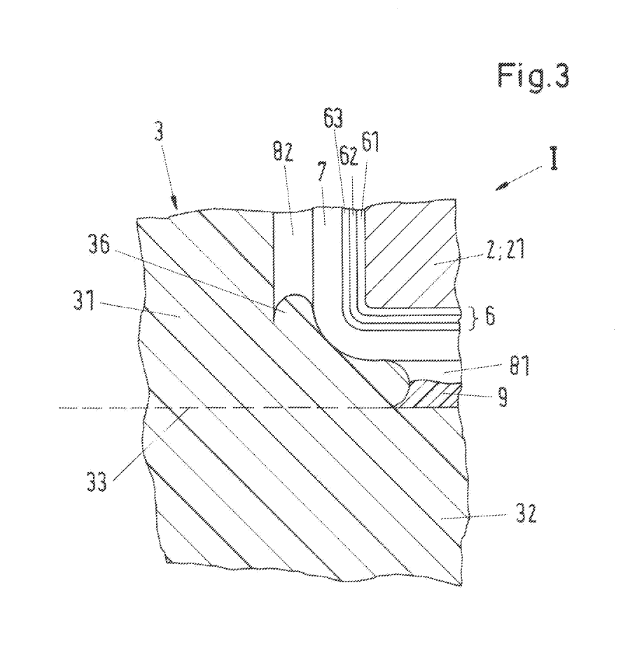

In the following, the rotor 1 will be explained in more detail with reference to FIG. 2 and FIG. 3, wherein FIG. 3 is an enlarged view of detail I of FIG. 2.

As already mentioned, in the first embodiment, the magnetically effective core 2 includes the ring-shaped permanent magnet 21, i.e. the magnetically effective core 2 is identical to the permanent magnet 21. The permanent magnet 21 preferably consists of (or includes) a neodyne-iron-boron (NdFeB) alloy, but it may also include another material, which is typically used for permanent magnets, a samarium-cobalt (SmCo) alloy, for example.

The permanent magnet 21 has a metallic coating 6, which serves in particular as protection against gaseous components of acidic or chemically aggressive substances and which should prevent or at least significantly reduce the diffusion of such components to the permanent magnet as far as possible. The metallic coating 6, which will be explained in more detail below, is disposed directly on the surface of the permanent magnet 21 in such a manner, wherein all surfaces of the permanent magnet 21 include the metallic coating 6, that the permanent magnet 21 is completely enclosed by the metallic coating 6. The metallic coating 6 is a hermetic encapsulation of the permanent magnet 21 preventing any substances from coming into direct contact with the permanent magnet 21.

Preferably, the metallic coating is deposited directly on each surface of the permanent magnet 21 by galvanic technology (electroplating) or by currentless metal deposition (chemical deposition without external current).

A plastic coating 7 is provided directly on the metallic coating 6, which plastic coating consists of (or includes) a polymer belonging to the family of parylenes. Those parylenes commercially available under the trade names parylene N, parylene C and parylene D are particularly suitable for the plastic coating. Parylene N is the basic product of this polymer family. Parylene N is poly(para-xylylene), a completely linear polymer. Parylene C and parylene D are variants, which are made from the same raw material as parylene N, wherein in parylene C one of the aromatic hydrogen atoms is replaced by a chlorine atom, and in parylene D two of the aromatic hydrogen atoms are each replaced by a chlorine atom. In particular, the plastic coating 7 may also consist of (or include) a fluorinated parylene and preferably of aliphatically fluorinated parylene. In this derivative, described as parylene AF4 and commercially available under the trade name parylene HT, for example, the two hydrogen atoms are replaced by two fluorine atoms in the aliphatic carbon bonds between the benzene rings.

The production of a plastic coating 7, which consists of (or includes) a parylene, is the state of the art per se and therefore does not require any further explanation. Usually, parylene coatings are produced by chemical vapor deposition. First, a suitable dimer, such as di-para-xylylene (or a halogenated, e.g. fluorinated derivative) is evaporated and passed through a high temperature zone (pyrolysis), whereby a monomer is formed (for example, para-xylylene). The monomers then polymerize on the surface to be coated, in this case on the metallic coating 6 enclosing the permanent magnet 21, whereby the parylene coating forms as the plastic coating 7.

In this case, it is also preferred, that the plastic coating 7 completely encloses the metallic coating 6 and thus, the permanent magnet 21. This means that the plastic coating 7 forms a second sheathing around the permanent magnet 21, which completely surrounds the metallic coating 6. The plastic coating 7 is provided directly on the metallic coating 6. For this purpose, the metallic coating 6 is used as substrate on which the parylene polymer is deposited during the production of plastic coating 7.

It is preferred to generate the plastic coating 7 in several successive coating processes, in each of which a parylene layer is deposited on the substrate. For this purpose, the permanent magnet 21 including the metallic coating 6 is turned at least once between the coating processes, so that the points of contact on which the permanent magnet 21 rests during a coating process are also covered during the subsequent coating process. In addition, more homogeneous and denser coatings can be produced by the multiple coating and also recesses in the permanent magnet 21 or in the metallic coating 6 can be coated homogeneously. In particular, at least three coating processes are carried out, in each of which a parylene layer is produced, so that the finished plastic coating 7 comprises at least three overlying parylene layers. The total thickness of the plastic coating 7 is preferably at least 40 micrometers, more preferably at least 60 micrometers and most preferably about 80 micrometers or more.

The rotor 1 further comprises the sheathing 3, which completely encloses the permanent magnet 21 and the metallic coating 6 completely enclosing the permanent magnet 21 and the plastic coating 7. Thus, the sheathing 3 forms a completely closed housing for the permanent magnet 21 and the coatings 6 and 7 provided on it. The sheathing 3 comprises a cup-shaped housing part 31, receiving the permanent magnet 21 with the metallic coating 6 and the plastic coating 7 and a cover 32 sealing the cup-shaped housing part 31 and being welded to the cup-shaped housing part 31 along a welding seam 33. The infrared welding process is preferred for welding the cover 32 to the housing part 31.

As already mentioned, the sheathing 3 consists of (or includes) a thermoplastically processible fluoropolymer, which is especially weldable. Particularly preferred, the sheathing 3 includes PFA. The sheathing 3 can also preferably includes ECTFE or PVDF.

Therefore, non-weldable plastics or non-weldable fluoropolymers, such as polytetrafluoroethylene (PTFE) known under the trade name Teflon, are not particularly suitable for the sheathing 3. Only weldable or PFA solderable PTFE compounds, which usually contain a small amount of PFA, may also be used.

Of course, the pump housing 101 may consist of (or include) a non-weldable plastic, in particular of a non-weldable fluoropolymer, such as PTFE.

The cup-shaped housing part 31 receiving the permanent magnet 21 comprises a substantially ring-shaped cavity into which the permanent magnet 21, which includes the metallic coating 6 and the plastic coating 7, is inserted. The depth T of the cavity 34, which means its extension in the axial direction A, is slightly larger than the extension of the permanent magnet 21—including the metallic coating 6 and the plastic coating 7—in the axial direction A, so that the housing part 31 protrudes over the permanent magnet 21 and over the plastic coating 7 with respect to the axial direction A—as shown in FIG. 2 and FIG. 3 downwards. When the cover 32 is placed on the housing part 31 or welded to it, there is an axial air gap 81 in each case between the plastic coating 7, which encloses the metallic coating 6 and the permanent magnet 21, and the cover 32 and the bottom of the cavity 34. The extension of the axial air gap 81 in the axial direction A is preferably about 0.5 mm-1 mm in each case.

In the radial direction, the cavity 34 has a width B, which is dimensioned such that a radial air gap 82 exists between the plastic coating 7, which encloses the metallic coating 6 and the permanent magnets 21, and the sheathing 3. The radial air gap 82 typically has a width (in the radial direction) of less than half a millimeter and is, for example, about 0.1 mm.

The cover 32 has an elevation 321, which protrudes from the cover 32 in the axial direction A, so that according to the illustration (FIG. 2), an axial air gap 81 exists in each case both above and below the permanent magnet 21 or the plastic coating 7. The plastic coating 7 with the metallic coating 6 and the permanent magnet 21 can support on this elevation 321, so that the axial air gap 81 is formed laterally next to the elevation 321. For example, the elevation 321 can be designed as a ring-shaped elevation 321, which is arranged concentrically to the set rotation axis and which is centered in the radial direction with respect to the permanent magnet 21.

Several anti-rotation devices 35 are provided, with which a torque can be transmitted from the permanent magnet 21 to the sheathing 3, so that the magnetically effective core 2, in this case the permanent magnet 21, cannot rotate relative to the sheathing 3, but instead takes the sheathing 3 as well as the vanes 4 and the cover plate 5 with it during its rotation. Each anti-rotation device 35 comprises a pin 351 extending in the axial direction A being an integral component of the cup-shaped housing part 31 of the sheathing 3, and a bore 352 provided in the permanent magnet, into which the respective pin 351 engages. For this purpose, each pin 351 and the respective bore 352 interacting with the pin 351 are designed in such a manner, that the permanent magnet 21 cannot rotate relative to the sheathing 3, but the rotation of the permanent magnet 21 is transmitted to the sheathing 3. Both the metallic coating 6 and the plastic coating 7 are also provided in each of the bores 352, so that the permanent magnet 21 is completely enclosed by the metallic coating 6 and the plastic coating 7. This means that both the metallic coating 6 and the plastic coating 7 are disposed between each bore 352 and the pin 351 engaging in it.

As shown in FIG. 3, the metallic coating 6 comprises a plurality of metallic layers, namely three, which are arranged one above the other. The innermost layer 61 is disposed directly on the surface of the permanent magnet 21, a middle layer 62 is disposed directly on the innermost layer 61 and an outermost layer 63 is disposed directly on the middle layer 62. The three layers 61, 62, 63 are applied successively, preferably by galvanic technology (electroplating) or by currentless metal deposition (chemical deposition without external current). Preferably, the innermost layer 61 and the outermost layer 63 each consists of (or includes) nickel (Ni). The middle layer preferably consists of (or includes) copper (Cu), but it may alternatively consist of (or include) gold (Au) or of rhodium (Rh). The total thickness of the metallic coating is preferably 30 to 100 micrometers and particularly preferred 50 to 60 micrometers. In this case, the innermost layer 61 has a thickness of about 10 to 20 micrometers; the middle layer 62 has a thickness of about 10 to 20 micrometers; and the outermost layer 63 has a thickness of about 30 micrometers.

Deviating from the illustration in FIG. 3, it is of course also possible that the metallic coating 6 has only one layer, which then preferably consists of (or includes) Ni or of Au or of Rh. It is also possible that the metallic coating 6 has two layers, the inner layer preferably consisting of (or including) Ni and the outer layer of Au or of Rh. Furthermore, it is possible that the metallic coating 6 comprises three or more layers 61, 62, 63.

In order to protect the plastic coating 7 in particular from excessive heat input during welding of the cover 32 to the cup-shaped housing part 31, which could lead to a degradation of the plastic coating 7, a heat protection film 9 is preferably disposed between the cover 32 of the sheathing 3 and the plastic coating 7. The heat protection film 9 is preferably a polyimide film, for example one commercially available under the trade name KAPTON. The heat protection film 9 is preferably only disposed between the underside of the plastic coating 7 according to the illustration (FIG. 2, FIG. 3) and the sheathing 3, i.e. in the area of the plastic coating 7, which is closest to the welding seam 33.

Alternatively or in addition to the heat protection film 9, it is a preferred measure that the plastic coating 7 consists of (or includes) a fluorinated parylene and particularly preferred of aliphatically fluorinated parylene, which is also designated as Parylene AF4. In particular, aliphatically fluorinated parylene has particularly high thermal stability.

In order to avoid temperature-related degradation of the plastic coating 7, especially when welding the cover 32 to the housing part 31 of the sheathing, several variants are preferred: The plastic coating 7 consists of (or includes) a non-fluorinated parylene, for example parylene N or parylene C or parylene D and the heat protection film 9 is provided. Or the plastic coating 7 consists of (or includes) a fluorinated parylene, in particular of aliphatically fluorinated parylene of the type parylene AF4, and no heat protection film 9 is provided. Or the plastic coating 7 consists of (or includes) a fluorinated parylene, in particular of aliphatically fluorinated parylene of the type Parylene AF4, and the heat protection film 9 is additionally provided.

To produce the rotor 1, the following procedure is preferred. First, the metallic coating 6 is applied to the ring-shaped permanent magnet 21, so that the permanent magnet is completely enclosed by the metallic coating. Subsequently, the plastic coating 7 is deposited from a parylene on the metallic coating 6, so that the metallic coating 6 is completely enclosed by the plastic coating 7. Then, the cup-shaped housing part 31 is provided. The permanent magnet 21 provided with the metallic coating 6 and with the plastic coating 7 is inserted into the ring-shaped cavity 34 of the housing part 31 in such a manner that the pins 351 engage in the bores 352. Optionally, the heat protection film 9 is placed on the surface of the plastic coating 7 facing the cover 32 or on the surface of the cover 32 facing the plastic coating. The cup-shaped housing part 31 with the permanent magnet 21 therein is covered or closed by placing the cover 32. Then, the lid 32 is welded by infrared welding to the cup-shaped housing part 31.

The air gaps 81, 82 are also advantageous with regard to welding, because along the welding seam 33 the fluoropolymer liquefied during welding, of which the sheathing 3 includes, can be displaced into this air gap 81, 82, so that there is no risk of the plastic coating 7 being damaged by displaced material. The polymer material displaced during welding is shown in FIG. 3 through the bead 36.

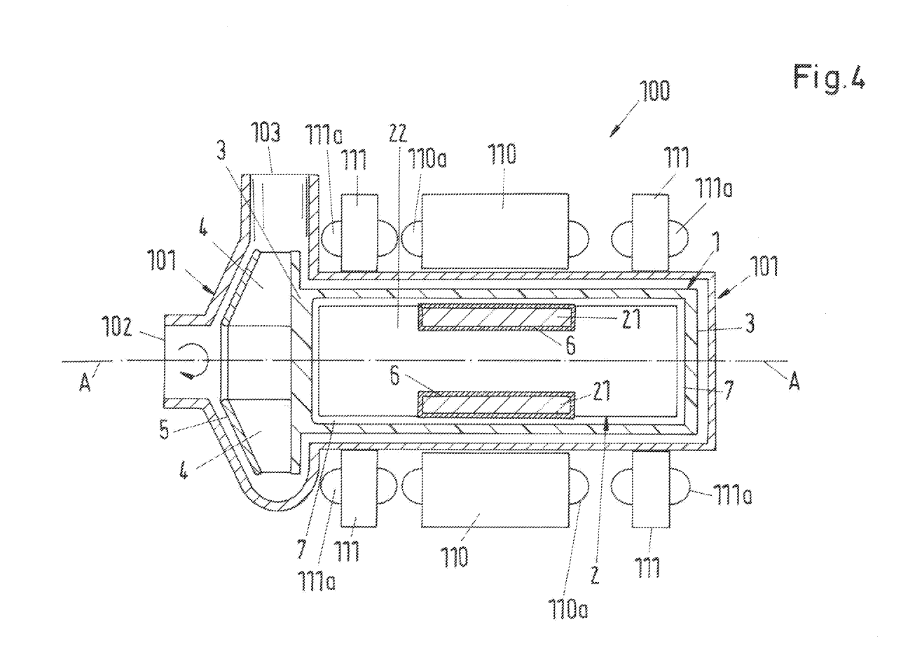

FIG. 4 shows a sectional view of a second embodiment of a rotary machine according to the invention with a second embodiment of a rotor according to the invention. In the following description of the embodiment of the rotary machine and the second embodiment of the rotor, only the differences to the first embodiment of the rotary machine and to the first embodiment of the rotor are explained. Otherwise, the explanations of the first embodiment of the rotor or the rotary machine are valid in the same way or in the same analogous way also for the second embodiment of the rotor or the rotary machine. In the second embodiment of the rotor or the rotary machine, the same parts or parts of the same function are referred to with the same reference signs as in the first embodiment of the rotor or the rotary machine.

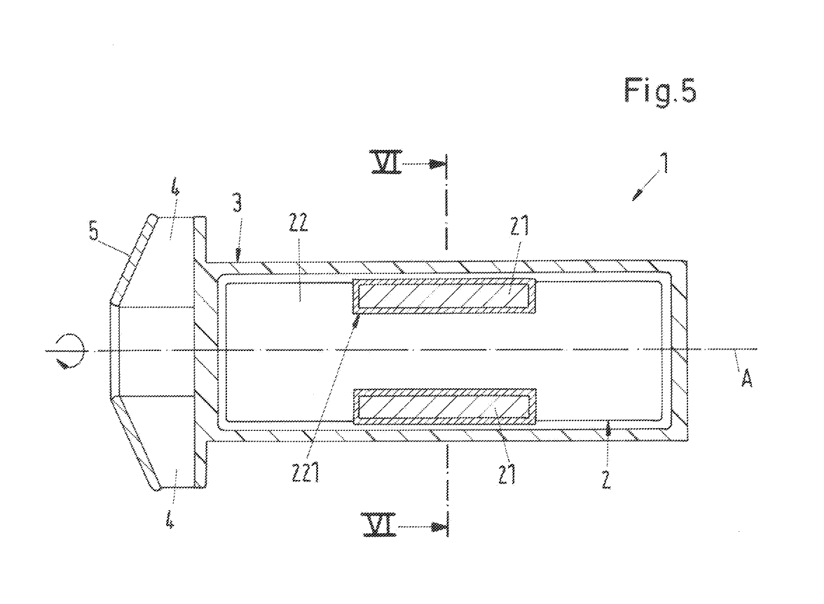

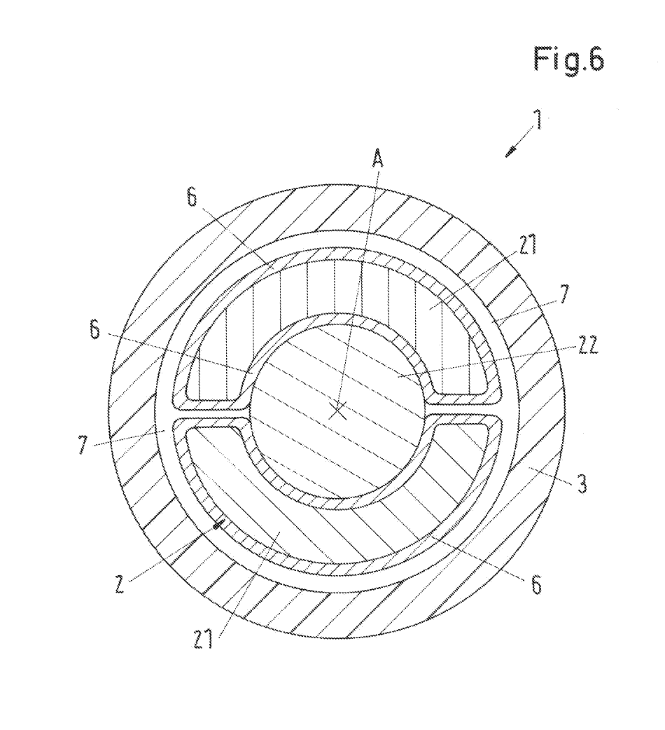

The second embodiment of the rotary machine according to the invention is also designed as a centrifugal pump 100 comprising the pump housing 101 with the inlet 102 and the outlet 103 for the fluid to be conveyed. The second embodiment of a rotor 1 according to the invention that can be magnetically levitated is disposed inside the pump housing 101. For a better understanding, FIG. 5 shows another sectional view of the rotor 1 that can be magnetically levitated of FIG. 4, and FIG. 6 shows a section through the rotor 1 of FIG. 5 along the section line VI-VI in FIG. 5, i.e. in a section perpendicular to axial direction A.

The rotor 1 has the magnetically effective core 2, which here comprises several permanent magnets 21, namely two permanent magnets 21, in order to drive the rotation of the rotor 1 about the set rotation axis, which determines the axial direction A. The magnetically effective core 2 comprises, in addition to the two permanent magnets 21, a base body 22, in which the permanent magnets 21 are embedded. The base body 22 includes a soft magnetic material such as iron, nickel-iron or silicon-iron. The base body 22 forms the magnetically effective core 2 of the rotor 1 together with the permanent magnets 21. The base body 22 and the permanent magnets 21 are designed in such a manner that the magnetically effective core 2 has a cylindrical shape overall, wherein the longitudinal axis of the cylindrical magnetically effective core 2 extends in the axial direction A.

The base body 22 has a substantially cylindrical shape with a ring-shaped recess 221 in the shell surface of the cylinder receiving the two permanent magnets 21. With respect to the axial direction A, the recess 221 is disposed in the center of the base body 22. Each of the two permanent magnets 21 is designed in such a manner as a curved segment, which has the shape of a hollow half cylinder that the two permanent magnets 21 complement each other substantially to a hollow cylinder. In this case, the recess 221 in the base body 22 and the two permanent magnets 21 are designed in such a manner, that the base body 22 and the two permanent magnets 21 complement each other to the substantially cylindrical magnetically effective core 2.

In contrast to the first embodiment being designed to the principle of the bearing-less motor, the drive function for the rotor 1 and the magnetic bearing function for the magnetically levitated rotor 1 are separated from each other in the second embodiment of the rotary machine 100 according to the invention. For this purpose, the centrifugal pump 100 has a drive stator 110 (FIG. 4), with which the rotation of the rotor 1 is driven about the axial direction A, and at least one bearing stator 111, in this case two bearing stators 111, with which the rotor 1 can be magnetically levitated and preferably levitated in a magnetically contactless manner with respect to the bearing stators 111. All stators 110, 111 are arranged radially outside with respect to the pump housing 101 and thus with respect to the rotor 1.

The drive stator 110 surrounds the pump housing 101 with respect to the axial direction A where the two permanent magnets 21 are arranged in the magnetically effective core 2 of the rotor 1, and interacts with the magnetically effective core 2 as an electromagnetic rotary drive. For this purpose, the drive stator 110 comprises one or several windings 110a with which an electromagnetic field can be generated, for example a rotating field driving the rotation of the rotor 1 around the axial direction A in a manner known per se. With regard to the design of the drive stator 110, all known designs are possible. It is only important that the rotation of the rotor 1 around the axial direction A can be driven with the drive stator 110.

The two bearing stators 111 for the magnetic levitation of the rotor 1 are arranged next to the drive stator 110 with respect to the axial direction A, wherein a bearing stator 111 is provided on each side of the drive stator 110, so that the drive stator 110 is arranged between the two bearing stators 111 with respect to the axial direction A. Preferably the two bearing stators 111 have the same distance from the drive stator 110. Each bearing stator 111 comprises one or more windings 111a with which electromagnetic fields can be generated, with which the rotor 1 can be magnetically levitated and preferably levitated in a magnetically contactless manner with respect to the bearing stators 111. In this case, each bearing stator 111 interacts with the magnetically effective core 2 of the rotor 1 according to the principle of a magnetic bearing. Since such magnetic bearings are known per se in numerous designs according to the state of the art, they do not require any further explanation here. The concrete design of the bearing stators 111 is not essential for the invention. It is only important that the rotor 1 with the bearing stator 111 or with the bearing stators 111 can be magnetically levitated and preferably levitated in a magnetically contactless manner.

According to the invention, also in the second embodiment of the rotor 1 according to the invention, the sheathing 3 includes a thermoplastically processible, in particular a weldable, fluoropolymer, which completely encloses the magnetically effective core 2. Furthermore, each permanent magnet 21 has the metallic coating 6, and the plastic coating 7 is provided between the metallic coating 6 and the sheathing 3, which plastic coating in turn includes a polymer belonging to the parylene family.

Also in the second embodiment of the rotor 1, the sheathing 3 preferably includes the weldable PFA. Alternatively, it is preferred if the sheathing 3 is made of ECTFE or PVDF.

In the second embodiment, the pump housing 101 preferably also includes a fluoropolymer, however, it does not have to be weldable or thermoplastically processible. Of course, it is also possible that the pump housing 101 includes the same plastic or polymer as the coating.

With regard to the design of the metallic coating 6 and the plastic coating 7 as well as the preferred materials for these coatings 6, 7, the explanations and definitions regarding the first embodiment are valid in the same way or in the same analogous way also for the second embodiment.

As shown in particular in FIG. 5 and FIG. 6, the metallic coating 6 is disposed directly on each permanent magnet 21. In doing so, each permanent magnet 21 is completely enclosed by the metallic coating 6 directly disposed on it.

The plastic coating 7 completely encloses the magnetically effective core 2. For this purpose, the plastic coating 7 is disposed directly on the surface of the base body 22 and directly on that area of the metallic coating 6 forming a part of the outer boundary surface of the magnetically effective core.

In the production of the rotor 1, therefore, the permanent magnets 21 are first provided with the metallic coating 6. In this case, the metallic coating 6 is deposited on all surfaces of each permanent magnet 21, so that each permanent magnet 21 is completely coated and encapsulated by the metallic coating 6. After the permanent magnets 21 are provided with the metallic coating 6, they are inserted into the recess 221 in the base body 22. Then, the plastic coating 7 is generated on the entire magnetically effective core 2, i.e. on the base body 22 and the permanent magnets 21 with the metallic coating 6 inserted therein, by depositing at least one and preferably several parylene layer(s), which completely encloses the magnetically effective core 2.

In the same analogous way as in the first embodiment, the sheathing 3 preferably comprises several parts again, for example two parts, whereby the magnetically effective core 2 provided with the plastic coating 7 is inserted into one of the parts and the two parts are then welded together.

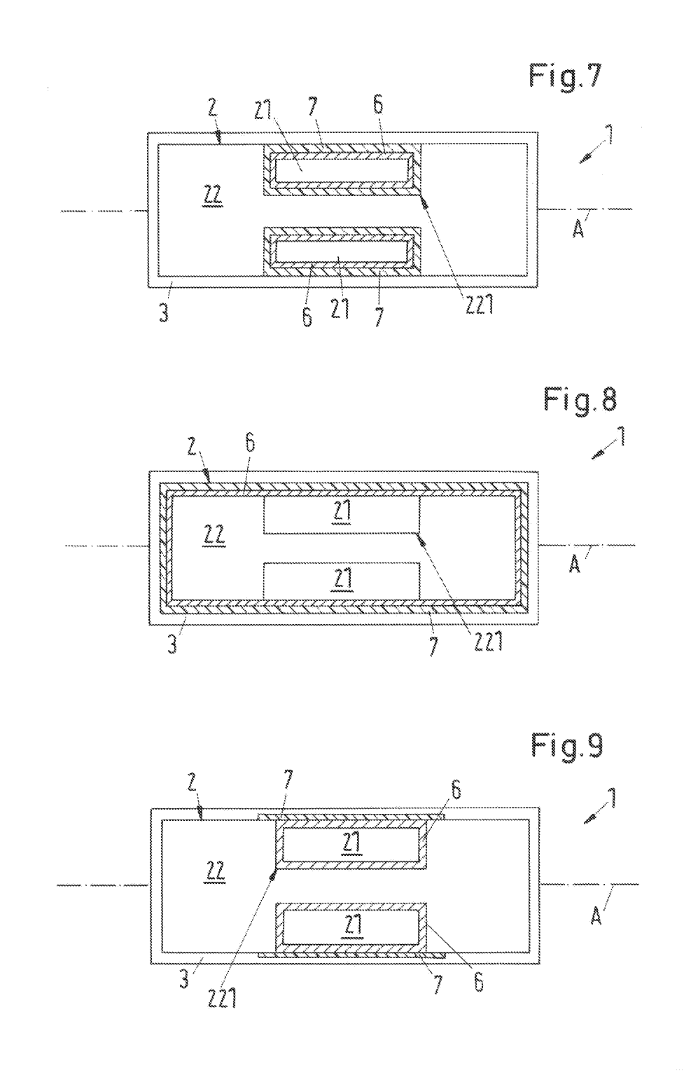

FIG. 7 shows a schematic view of a first variant for the second embodiment of the rotor 1 that can be magnetically levitated. The vanes 4 and the cover plate 5 of the rotor 1 are not shown in FIG. 7.

In this first variant, the plastic coating 7 does not enclose the entire magnetically effective core 2 of the rotor 1, but only each of the two permanent magnets 21 with the metallic coating 6 disposed on it.

For this first variant, the permanent magnets 21 are first provided with the metallic coating 6. For this purpose, the metallic coating 6 is deposited on all surfaces of each permanent magnet 21, so that each permanent magnet 21 is completely coated and encapsulated by the metallic coating 6. After the permanent magnets 21 are provided with the metallic coating 6, the plastic coating 7 is generated on each metallic coating 6 by depositing at least one and preferably several parylene layer(s), completely enclosing the metallic coating 6 and the permanent magnet 21 enclosed by it.

Subsequently, the permanent magnets 21 provided with the metallic coating 6 and the plastic coating 7 are inserted into the recess 221 in the base body 22. Then, the sheathing 3 is completely encloses the magnetically effective core 2 of the rotor 2.

FIG. 8 shows a schematic view of a second variant for the second embodiment of the rotor 1 that can be magnetically levitated. The vanes 4 and the cover plate 5 of the rotor 1 are not shown in FIG. 8.

In the second variant, the entire magnetically effective core 2 is completely enclosed by both the metallic coating 6 and the plastic coating 7. In this variant, the metallic coating 6 does not directly and completely enclose the individual permanent magnets 21, but only those surfaces of the permanent magnets 21 forming a part of the radially outer surface of the magnetically effective core 2, are directly provided with a metallic coating 6.

For this second variant, the permanent magnets 21, which have not yet been coated, are first inserted into the recess 221 in the base body 22. Then, the entire magnetically effective core 2—i.e. the base body 22 with the permanent magnets 21 inserted therein—is provided with the metallic coating 6. In doing so, the metallic coating 6 is deposited on all surfaces of the magnetically effective core 2, so that it is completely coated and it is completely enclosed by the metallic coating 6. After the magnetically effective core 2 has been provided with the metallic coating 6, the plastic coating 7 is generated directly on this metallic coating 6 by depositing at least one and preferably several parylene layer(s), which completely encloses the metallic coating 6 and the magnetically effective core 2 enclosed by it. Then the sheathing 3 is provided, which completely encloses the magnetically effective core 2 of the rotor 1.

FIG. 9 shows in a schematic view a third variant for the second embodiment of the rotor 1 that can be magnetically levitated. The vanes 4 and the cover plate 5 of the rotor 1 are not shown in FIG. 9.

In the third variant, the metallic coating 6 is disposed directly on each permanent magnet 21 again. In this case, each permanent magnet 21 is completely enclosed by the metallic coating 6 provided directly on it. The plastic coating 7 does not enclose the entire magnetically effective core 2 of the rotor 1, but only covers the area of the metallic coating 6 of each permanent magnet 21, which forms a part of the radially outer surface of the magnetically effective core 2. This means that only the radially outer surface of the metallic coating 6 is covered by the plastic coating 7 in each case. It is preferred that the plastic coating 7 extends slightly further with respect to the axial direction A than the metallic coating 6, so that the boundary area between the metallic coating 6 and the recess 221 in the base body 22 is covered and protected against the penetration of acidic or chemically aggressive substances. The plastic coating 7 is therefore preferably designed in such a manner that it has a small overlap with the base body 22 on both sides with respect to the axial direction A. Since parylenes penetrate scratches, cracks or gaps very well, it is ensured that in particular the permanent magnets 21 are protected, especially against the penetration of substances into the boundary between the metallic coating 6 on the permanent magnets and the recess 221 in the base body 22.

For this third variant, first the permanent magnets 21 are each provided with the metallic coating 6. In this case, the metallic coating 6 is deposited on all surfaces of each permanent magnet 21, so that each permanent magnet 21 is completely coated and encapsulated by the metallic coating 6. After the permanent magnets 21 are provided with the metallic coating 6, they are inserted into the recess 221 in the base body 22. Subsequently, the radially outer surfaces of each metallic coating 6 are coated with a parylene. For this purpose, the plastic coating 7 is generated directly on these surfaces of the metallic coating 6 by depositing at least one and preferably several parylene layer(s), the plastic coating 7 being produced in such a manner that it overlaps slightly with the base body 22 on both sides with respect to the axial direction A. This can be realized, for example, by covering or masking the areas of the base body 22 that are not to be coated during deposition of the parylene layers.

After completion the plastic coating 7, the sheathing 3 is provided, which completely encloses the magnetically effective core 2 of the rotor 1.

The rotor 1 that can be magnetically levitated according to the invention and the rotary machine 100 according to the invention, especially in their design as centrifugal pump or mixing device, are particularly suitable for applications in the semiconductor industry, especially for the production processes of semiconductors or semiconductor chips.

1. A magnetically levitated rotor for a rotary machine, the rotor comprising:
a magnetically effective core;
a sheathing made of a thermoplastically processible fluoropolymer, the sheathing completely enclosing the magnetically effective core, the magnetically effective core comprising at least one permanent magnet and each permanent magnet has a metallic coating configured to protect against acidic or chemically aggressive substances; and
a plastic coating disposed between the metallic coating and the sheathing, the plastic coating including a polymer belonging to the family of parylenes.

2. The rotor according to claim 1, wherein the metallic coating comprises at least one layer including nickel or gold or rhodium.

3. The rotor according to claim 1, wherein the metallic coating comprises a plurality of layers arranged one above the other, and the innermost layer is disposed directly on a surface of the permanent magnet and includes nickel.

4. The rotor according to claim 1, wherein the metallic coating comprises exactly three layers arranged one above the other, and the innermost layer and the outermost layer each includes nickel and the intermediate middle layer includes copper or gold or rhodium.

5. The rotor according to claim 1, wherein the sheathing includes a perfluoroalkoxy polymer or ethylene chlorotrifluoroethylene or polyvinylidene fluoride.

6. The rotor according to claim 1, further comprising a heat protection film between the plastic coating and the sheathing.

7. The rotor according to claim 1, wherein the plastic coating includes a fluorinated parylene.

8. The rotor according to claim 1, wherein the metallic coating completely encloses the magnetically effective core.

9. The rotor according to claim 1, wherein the plastic coating completely encloses the magnetically effective core.

10. The rotor according to claim 1, wherein the metallic coating is disposed directly on the at least one permanent magnet and the at least one permanent magnet is completely enclosed by the metallic coating.

11. The rotor according to claim 10, wherein the plastic coating is disposed directly on the metallic coating and the metallic coating is completely enclosed by the plastic coating.

12. The rotor according to claim 1, wherein the magnetically effective core includes a permanent magnet.

13. The rotor according to claim 1, wherein the sheathing has a cup-shaped housing part, which receives the magnetically effective core, and a cover welded to the housing part, the cup-shaped housing part being configured such that an air gap exists between the magnetically effective core and the housing part.

14. A centrifugal pump for affecting a fluid, comprising:
the magnetically levitated rotor according to claim 1; and
a stator, the rotor being configured to be driven in a magnetically contactless manner for rotation about an axial direction in an operating state.

15. The rotary machine according to claim 14, wherein the rotary machine is a bearing-less motor, and the stator is a bearing stator and drive stator and the rotor is configured to be levitated in a magnetically contactless manner at least radially with respect to the stator.

16. The rotor according to claim 1, further comprising a heat protection film between the plastic coating, and the heat protection film being a polyimide film.

17. The rotor according to claim 1, wherein the plastic coating includes aliphatically fluorinated parylene.

18. The rotor according to claim 1, wherein the magnetically effective core includes a permanent magnet, the permanent magnet being a one piece ring.
